(19) United States
(12) Patent Application Publication
(10) Pub. No.: US 2026/0243635 A1
(43) Pub. Date: Aug. 20, 2026

(54) A ROCKING SHAKER FOR TREATING AT LEAST ONE FLUID SAMPLE

(71) Applicant: MERZ PHARMA GMBH & CO. KGAA, Frankfurt am Main (DE)

(72) Inventor: Karl-Heinz EISELE, Usingen (DE)

(21) Appl. No.: 19/164,881

(22) PCT Filed: Mar. 14, 2024
(86) PCT No.: PCT/EP2024/056827

§ 371 Date: Sep. 12, 2025

(30) Foreign Application Priority Data
Mar. 15, 2023 (EP) 23161977.6

(51) Int. Cl. G01N 1/38; B01F 31/20; B01F 31/23; B01F 35/222; B01F 101/22

(52) U.S. Cl. CPC G01N 1/38; B01F 31/201; B01F 31/23; B01F 35/222; B01F 2101/22; G01N 2001/386

(57) ABSTRACT

A rocking shaker (110) for treating at least one fluid sample is disclosed. The rocking shaker (110) comprises: i. at least one mechanical frame (112), the mechanical frame (112) comprising at least one tilting axle (114); ii. at least one mounting platform (128) being tiltably mounted on the tilting axle (114), the mounting platform (128) being configured for receiving at least one sample holder; iii. at least one actuator (136), the actuator (136) being configured for periodically tilting the mounting platform (128) about the tilting axle (114) over an angular orientation range; and iv. at least one driving circuit (220) for electrically driving the actuator (136), the driving circuit (220) comprising at least one switch-off device (222), the switch-off device (222) being configured for automatically bringing the mounting platform (128) in a predetermined switch-off orientation when the rocking shaker (110) is switched off.

### TECHNICAL FIELD

The invention relates to a rocking shaker for treating at least one fluid sample, a system comprising at least one rocking shaker and a method for treating at least one fluid sample. The devices and methods may have broad applications in the field of chemical, biochemical and biological analysis. Specifically, the invention may be used in the field of cell-based assays (CBA). Other applications, however, are also feasible.

### BACKGROUND ART

Different options are currently available for mixing liquids and suspensions in automated liquid handling. The different options may include a mixing by pipetting, an application of orbital shakers, magnetic stirrers, teeter shakes, totter shakers, overhead shakers, and/or of stirrer motors.

Generally, the options as listed above may require a customization of both hardware and control software.

When mixing by pipetting, a simultaneous addition of liquid is generally not possible, since a utilized pipetting unit may be occupied by a mixing process. A second pipetting unit principally cannot be used for this purpose either, specifically for reasons of space. Devices with, for example, an additional pump would be an individual special design. In addition, a volume for mixing is usually limited to 8 ml×1 ml and a frequent aspiration and ejection of a cell suspension typically exerts considerable shear stress on the cells.

Orbital shakers are particularly suitable for round vessels. Optimum mixing results may be achieved when a shaking orbit, a filling volume and a vessel geometry are matched. However, if solutions or suspensions are diluted during the mixing process due to simultaneous addition of liquid, these parameters may continuously change and may thereby affect the mixing efficiency. Furthermore, square vessels are generally preferred as reservoirs in automated liquid handling.

Overhead shakers generally require tightly sealed vessels and are therefore not suitable for adding liquids for dilution during the mixing process.

Agitators and magnetic stirrers, like orbital shakers, are generally more suitable for round vessels. Their mixing efficiency generally shows a clear optimum which may depend on a sample volume, vessel dimensions, a rotation speed and a stirrer geometry. Especially for small volumes where efficient mixing may be particularly important, their mixing efficiency may be poor. In addition, large shear forces may occur in a gap between a stirrer magnet and a bottom of the vessel. Further, by placing the stirrer above the vessel, an access for an addition of liquid through a pipetting unit may be blocked.

Rocking shakers may be well suited for an intended purpose of handling cell-based assays as they are used for example for Botulinum neurotoxin activity determination as described in WO 2014/207109 A1, WO 2013/049508 A1 or WO 2009/114748 A1. Rocking shakers may allow an open access for a pipetting unit to add liquid, the mixing efficiency at small volumes may be particularly high and rocking shakers may in particular be well suited for rectangular vessels. However, commercially available rocking shakers generally have several disadvantages. Rocking shakers which have a format corresponding to a microplate according to a standard ANSI/SBS are generally not available. Commercially available rocking shakers are usually at least 15 cm×25 cm in size and therefore generally take up an excessive amount of space on a deck of a liquid handling platform. Further, special mounts are generally needed to securely hold a microplate in place. Further, after switching off, the rocking generally remains at a random angle so that no safe handling by a robot can take place due to an unknown inclination and/or position. Further, commercially available rocking shakers generally cannot be controlled by a robot software.

Generally, handling of cell-based assays leads to great demands on technical staff, specifically as the processes are typically lengthy and highly complex. An at least partial automation of the cell-based assays may result in a reduction of errors such as mix-ups, physical stress such as lengthy pipetting in constrained postures and an improved precision of results. In cell-based assays, consistency and high quality of cell cultures usually play a critical role. Small deviations from a protocol during cell handling—i.e. thawing, seeding and maintaining—may have a strong impact on an overall quality of the cell-based assay. In addition, utilized materials such as cells and media are usually limited and expensive. Thus, it is generally advantageous to use them as sparingly as possible.

In many chemical, biochemical and biological processes including analytical assays, simultaneous mixing and addition of a liquid to a sample is desirable. This may include a dilution of stock solutions or stock suspensions. In particular, mechanically sensitive suspended particles may require gentle mixing conditions. In some cases, a combination of continuous and controlled addition of liquid under gentle though efficient mixing may be essential for achieving a consistently high quality of a final mixture. One example may be a process of diluting cell suspensions from a frozen stock in a process of cell seeding since thawed cells are commonly very delicate with regard to mechanical stress and a change of medium conditions due to cryo protectant chemicals in the stock suspensions.

### Problem to be Solved

It is therefore desirable to provide a rocking shaker for treating at least one fluid sample, a system comprising at least one rocking shaker and a method for treating at least one fluid sample which at least partially address the above-mentioned technical challenges. Specifically, a handling of a liquid sample shall be facilitated.

### SUMMARY

This problem is addressed by a rocking shaker for treating at least one fluid sample, a system comprising at least one rocking shaker and a method for treating at least one fluid sample with the features of the independent claims. Advantageous embodiments which might be realized in an isolated fashion or in any arbitrary combinations are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a rocking shaker for treating at least one fluid sample is disclosed. The rocking shaker comprises:
i. at least one mechanical frame, the mechanical frame comprising at least one tilting axle;
ii. at least one mounting platform being tiltably mounted on the tilting axle, the mounting platform being configured for receiving at least one sample holder;
iii. at least one actuator, the actuator being configured for periodically tilting the mounting platform about the tilting axle over an angular orientation range; and
iv. at least one driving circuit for electrically driving the actuator, the driving circuit comprising at least one switch-off device, the switch-off device being configured for automatically bringing the mounting platform in a predetermined switch-off orientation when the rocking shaker is switched off.

The term “fluid sample” as used herein is a broad term and is to be given its ordinary and customary meaning to a person of ordinary skill in the art and is not to be limited to a special or customized meaning. The term specifically may refer, without limitation, to an arbitrary sample such as a biological sample or a synthetic sample. The sample may specifically be a liquid sample, in particular a liquid sample comprising at least one biological material. The sample may be used directly as obtained from the respective source or may be subject of a pretreatment and/or sample preparation workflow. Further, the sample may undergo one or more treatment steps. Thus, at least one property of the sample may change. Specifically, the sample may be or may comprise a cell suspension. The cell suspension may comprise single cells or small aggregates of cells as well as a growth medium. The cells may be allowed to function and multiply in the growth medium. Further, the fluid sample may comprise beads and/or particles. Specifically, a suspension comprising beads and/or particles may be added to the biological sample such as to the cell suspension during one or more treatment steps of the biological sample.

The term “treating at least one fluid sample” as used herein is a broad term and is to be given its ordinary and customary meaning to a person of ordinary skill in the art and is not to be limited to a special or customized meaning. The term specifically may refer, without limitation, to an arbitrary process step wherein at least one property of the fluid sample may change. The treating of the at least one fluid sample may specifically refer to a process step of a cell culture method where live cells are grown in vitro and used as model systems to assess the biochemistry and physiology of healthy and/or diseased cells. Specifically, the treating of the at least one fluid sample may refer to a mixing of components of the fluid sample. Further, the treating of the at least one fluid sample may refer to a dilution of the fluid sample. Also other kind of treatments may be feasible.

The term “rocking shaker” as used herein is a broad term and is to be given its ordinary and customary meaning to a person of ordinary skill in the art and is not to be limited to a special or customized meaning. The term specifically may refer, without limitation, to an arbitrary device which is configured for shaking at least one fluid sample, specifically at least one fluid sample in a vessel, by performing a rocking movement, specifically a periodical rocking movement. Specifically, as will be outlined in further detail below, the rocking shaker may comprise a support platform for the liquid sample, specifically for the vessel comprising the liquid sample, and the rocking shaker may be configured for conducting the rocking movement, specifically the periodical rocking movement, of the support platform. Further details on the components of the rocking shaker are provided below in more detail.

As outlined above, the rocking shaker comprises the at least one mechanical frame. The term “mechanical frame” as used herein is a broad term and is to be given its ordinary and customary meaning to a person of ordinary skill in the art and is not to be limited to a special or customized meaning. The term specifically may refer, without limitation, to any arbitrary frame which is configured for holding an arbitrary element such as an axle in a desired position. Specifically, the mechanical frame may comprise a housing of the rocking shaker or may form part of the housing of the rocking shaker. The housing may be configured for receiving one or more components of the rocking shaker such as the actuator or the driving circuit at least partially. For this purpose, the mechanical frame may comprise at least one hollow space. The mechanical frame may specifically comprise two recessing, specifically two opposing recesses, for supporting the axle. The two recesses may be configured for respectively receiving an end of the axle. Specifically, the recesses may be located on two opposing sidewalls of the mechanical frame.

As outlined above, the mechanical frame comprises the at least one tilting axle. The term “tilting axle” as used herein is a broad term and is to be given its ordinary and customary meaning to a person of ordinary skill in the art and is not to be limited to a special or customized meaning. The term specifically may refer, without limitation, to an arbitrary element which is configured for supporting one or more rotating components. The tilting axle may specifically be a stationary element. The tilting axle may be stationary with respect to linear movements. The tilting axle may have an ability to rotate around an axis. Thus, the one or more rotating components may be mounted on the tilting axle. The tilting axle may have a load bearing and/or storage function. The tilting axle may be subjected to bending stresses but does not transmit torque. The tilting axle may specifically be an elongated element, specifically an essentially cylindrical element.

As outlined above, the rocking shaker comprises the at least one mounting platform. The term “mounting platform” as used herein is a broad term and is to be given its ordinary and customary meaning to a person of ordinary skill in the art and is not to be limited to a special or customized meaning. The term specifically may refer, without limitation, to an arbitrary element having at least one support area, specifically at least one essentially flat support area. The at least one fluid sample, specifically the at least one sample holder comprising the fluid sample, may be configured for being mounted on the mounting platform. Specifically, the at least one fluid sample, specifically the at least one sample holder comprising the fluid sample, may be configured for being mounted on the mounting platform in a fixed manner. An overall footprint of the mounting platform may match dimensions of the sample holder. Thus, during movement of the mounting platform, a relocating of the at least one sample holder comprising the fluid sample may be prevented at least to a large extent. The at least one sample holder comprising the fluid sample may be mounted onto the mounting platform in a releasable manner. As further used herein, the term “releasable”, in the context of the mechanical connection, generally refers to the fact that the mechanical connection may be brought from a disconnected state, also referred to as a non-mated state, into a connected state, also referred to as a mated state, and back into the disconnected state. Thus, the mechanical connection may be closed and released at will. Specifically, the mechanical connection may be releasable without using any tools, simply by manual action. Further details on the design of the mounting platform will be given below in more detail.

As outlined above, the mounting platform is tiltably mounted on the tilting axle. Specifically, the mounting platform may be mounted on the tilting axle such that a rotation of the mounting platform around a rotation axis is enabled. The rotation axis may correspond to a longitudinal axis of the tilting axle. The term “being tiltably mounted on the tilting axle” may refer to embodiments wherein the mounting platform is fixed on an axle that is able to rotate, e.g. by being mounted on the mechanical frame such as via bearings. Further, the term “being tiltably mounted on the tilting axle” may refer to embodiments wherein the mounting platform is tiltably mounted on a fixed, specifically rigid, axle such as via bearings.

Specifically, the rocking shaker may comprise at least one rotating component. The rotating component may have at least one through hole and the tilting axle may be received within the through hole of the rotating component. Specifically, the rocking shaker may comprise two of the rotating components which may respectively be located on opposing ends of the tilting axle. The mounting platform may be fixedly connected to the at least one rotating component. Exemplarily, the mounting platform may be fixedly connected to the at least one rotating component by at least one screw connection.

As outlined above, the mounting platform is configured for receiving the at least one sample holder. The term “sample holder” as used herein is a broad term and is to be given its ordinary and customary meaning to a person of ordinary skill in the art and is not to be limited to a special or customized meaning. The term specifically may refer, without limitation, to any arbitrary object which may be configured for holding, specifically reversibly or releasably, at least one sample. Specifically, the sample may be a liquid sample and the sample holder may be or may comprise at least one vessel for receiving the liquid sample. Specifically, the sample holder may comprise at least one microplate having a plurality of wells for receiving the liquid sample, either directly or contained in at least one additional sample container. The term “microplate” as used herein is a broad term and is to be given its ordinary and customary meaning to a person of ordinary skill in the art and is not to be limited to a special or customized meaning. The term specifically may refer, without limitation, to an essentially flat plate comprising a plurality of wells, e.g. cavities, which are isolated from each other. The wells may be arranged in rows and columns. The microplate may also be referred to as microwell plate or multiwall. The wells may be utilized as small test tubes. The microplate may be applied for an analysis of biological properties of the liquid sample. The microplate may have a rectangular shape. The microplate may be made of at least one plastic material such as polystyrene or of glass. The exact dimensions of the microplate may correspond to an ANSI standard on the recommendation of the Society for Biomolecular Screening (SBS). Specifically, the microplate may be a microplate according to standard ANSI/SBS 2004, more specifically to at least one of standards ANSI/SBS 1-2004, ANSI/SBS 2-2004, ANSI/SBS 3-2004 and ANSI/SBS 4-2004. However, also other embodiments may be feasible. Specifically, the microplate may have at least one outside flange for mating with the mounting platform, more specifically with a positioning contour of the mounting platform.

The mounting platform may comprise at least one essentially flat mounting surface and at least one positioning contour for positioning the sample holder on the mounting platform. As generally used, the term “flat” refers to a property of a body comprising extensions in two dimensions, typically denoted as “surface” of the flat body, which exceed the extension in a third dimension, usually denoted as “thickness” of the planar body, by a factor of 2, at least a factor of 5, at least a factor of 10, or even at least a factor of 20 or more. The mounting platform may specifically have an essentially rectangular footprint having a length L and a width W, specifically a length L of 80 mm to 200 mm, more specifically a length of 100 mm to 150 mm, more specifically a length of 128 mm, and, specifically, a width W of 40 mm to 120 mm, specifically a width of 50 mm to 110 mm, more specifically a width of 86 mm. However, also other dimensions may be feasible. The term “positioning contour” may generally refer to an arbitrary part of an element which is configured to interact with a counterpart contour of another element in order to form a connection between the two elements. Thus, the contour and the counterpart contour may be complementary contours configured for forming a connection. Therein, one of the contours and the counterpart contour may comprise at least one protrusion and, in a complementary fashion, the other one of the contours and the counterpart contour may comprise at least one groove or slot in which the protrusion may be guided. The positioning contour may specifically be configured for mating with the at least one microplate according to standard ANSI/SBS 2004, more specifically to at least one of standards ANSI/SBS 1-2004, ANSI/SBS 2-2004, ANSI/SBS 3-2004 and ANSI/SBS 4-2004. Specifically, the positioning contour may comprise a circumferential groove for mating with at least one flange of at least one microplate, specifically with a bottom outside flange of at least one microplate according to standard ANSI/SBS 3-2004. The circumferential groove may specifically define a closed groove along the essentially flat mounting surface of the mounting platform. Further, the positioning contour may comprise one or more circumferential raised rim sections, specifically at corners of the mounting platform. Specifically, the corners of the mounting platform may have elevations.

As outlined above, the rocking shaker comprises the at least one actuator. The term “actuator” as used herein is a broad term and is to be given its ordinary and customary meaning to a person of ordinary skill in the art and is not to be limited to a special or customized meaning. The term specifically may refer, without limitation, to an arbitrary combination of devices which are configured for converting an electrical signal into mechanical movements. The actuator may be operated by a source of electrical energy and may convert energy into motion. The actuator may have an adjustable agitation speed. The actuator may specifically comprise at least one electric motor. The motor may specifically be selected from the group consisting of: an electric DC motor; a gear motor, specifically a DC gear motor; a stepper motor; a servo motor, specifically a computer or microcontroller controlled servo motor. Also, other kind of electric motors may be feasible. The rocking shaker, specifically the actuator, may comprise at least one of an external electric power supply and an internal electric power storage device, specifically at least one of an accumulator and a battery. The external electric power supply and the internal electric power storage device may be configured for operating the actuator.

The electric motor may be mechanically coupled to the mounting platform. Exemplarily, the actuator may comprise an eccentric drive. The term “eccentric drive” as used herein is a broad term and is to be given its ordinary and customary meaning to a person of ordinary skill in the art and is not to be limited to a special or customized meaning. The term specifically may refer, without limitation, to an arbitrary element which is configured for converting rotary motion into translational movements and vice versa. The eccentric drive may specifically comprise at least one disk, specifically at least one circular disk. At least one eccentric rod may be attached to the circular disk. An end of the eccentric rod may be attached to the circular disk in such a way that an opposing further end of the eccentric rod may impart the desired rotary motion into translational movement which may specifically be a reciprocating motion.

In case the motor is a step motor or a servo motor, the eccentric drive may be attached either directly to the tilting axle or to the mounting platform in its rotary center or off-center of the rotation axis via a wire-, gear- or connecting rod assembly. Said rod assembly may be connected to the mounting platform either directly or via a spring which may specifically gain some protection of the mechanical system against damage in case of external malfunction.

As outlined above, the actuator is configured for periodically tilting the mounting platform about the tilting axle over an angular orientation range, specifically over an angular orientation range from 5° to 40°.

As outlined above, the rocking shaker comprises the at least one driving circuit for electrically driving the actuator. The term “driving circuit” as used herein is a broad term and is to be given its ordinary and customary meaning to a person of ordinary skill in the art and is not to be limited to a special or customized meaning. The term specifically may refer, without limitation, to an arbitrary electrical network with a closed-loop giving a return path for current. The electrical network may be or may comprise an interconnection of electrical components. The driving circuit may specifically be configured for controlling another circuit or component such as a motor. The driving circuit may specifically be configured for regulating current flowing through a circuit or for controlling other components such as a device in the circuit. Different components of the driving circuit are described below in more detail.

As outlined above, the driving circuit comprises the at least one switch-off device. The term “switch-off device” as used herein is a broad term and is to be given its ordinary and customary meaning to a person of ordinary skill in the art and is not to be limited to a special or customized meaning. The term specifically may refer, without limitation, to an arbitrary electrical component which is configured for connecting or disconnecting a conducting path in an electrical circuit, interrupting an electric current and/or for diverting the electric current from one conductor to another conductor. Different components of the switch-off device are described below in more detail.

As outlined above, the switch-off device is configured for automatically bringing the mounting platform in a predetermined switch-off orientation when the rocking shaker is switched off. The term “automatically” as used herein is a broad term and is to be given its ordinary and customary meaning to a person of ordinary skill in the art and is not to be limited to a special or customized meaning. The term specifically may refer, without limitation, to a process which is performed completely by means of at least one computer and/or computer network and/or machine, in particular without manual action and/or interaction with a user. Specifically, the switch-off device may exclusively be computer-controlled. The term “switch-off orientation” as used herein is a broad term and is to be given its ordinary and customary meaning to a person of ordinary skill in the art and is not to be limited to a special or customized meaning. The term specifically may refer, without limitation, to an orientation of the mounting platform of the rocking shaker which the mounting platform takes in case the rocking shaker is switched off. The term “predetermined switch-off orientation” as used herein is a broad term and is to be given its ordinary and customary meaning to a person of ordinary skill in the art and is not to be limited to a special or customized meaning. The term specifically may refer, without limitation, to a specific orientation of the mounting platform of the rocking shaker which is desired and defined prior to actually taking the orientation. Specifically, the mounting platform, specifically a support surface of the mounting platform, may be in an essentially horizontal orientation when the mounting platform is in the switch-off orientation. The term “essentially”, as used herein and as used below, specifically may comprise tolerances of no more than 10%, specifically of no more than 5%. Specifically, the switch-off device may be configured for automatically bringing the mounting platform in the predetermined switch-off orientation independent from a point in time at which the rocking shaker is switched off. Thus, the mounting platform may be brought into the predetermined switch-off orientation independently from a previous duration of operation of the rocking shaker. Further, the mounting platform may be brought into the predetermined switch-off orientation independently from an orientation of the mounting platform at the moment the actuator is switched off.

Specifically, the switch-off device may comprise at least one main switch. The main switch may be configured for being actuated externally. Specifically, the main switch may be configured for being actuated by a user of the rocking shaker. The main switch may be configured for switching on the rocking shaker, specifically the actuator, as well as for switching off the rocking shaker, specifically the actuator. Specifically, the main switch may comprise a switching element switchable by a user. Exemplarily, the switching element switchable by a user may be or may comprise at least one toggle switch. The toggle switch may be manually actuated by a mechanical lever or handle. The switching element may have at least two switching positions. The switching positions may comprise an ON position in which the actuator is switched on. The switching positions may further comprise an OFF position in which the actuator is switched off. Further, optionally, the switching positions may comprise a computer control position in which a switching on and a switching off of the actuator is controllable by an external computer. Specifically, the main switch may be switchable by at least one of: by manual switching and by external computer control. Specifically, the main switch may be exclusively switchable by external computer control. The main switch may comprise a main switching circuit. The main switching circuit may comprise at least two branches connected in a parallel fashion. A current flow may be switchable between the branches. In at least one of the branches a computer controllable switch may be located.

Further, specifically, the main switch may comprise at least one relay. The term “relay” as used herein is a broad term and is to be given its ordinary and customary meaning to a person of ordinary skill in the art and is not to be limited to a special or customized meaning. The term specifically may refer, without limitation, to an arbitrary remotely operated switch operated by electric current, usually with two switching positions. The relay may be activated by a control circuit and may be configured for switching other circuits. The relay may specifically be a mechanical relay. The relay may specifically comprise at least one excitation coil. A current in the excitation coil may generate a magnetic flux through a ferromagnetic core of the excitation coil and a movable armature, which may also be ferromagnetic. At an air gap, force may be applied to the armature, causing it to switch one or more contacts. The armature may be returned to its initial position such as by a spring force as soon as the excitation coil is no longer energized.

Further, the switch-off device may comprise at least one orientation-sensitive switch. The orientation-sensitive switch may be configured for being switched by an orientation of the mounting platform. Specifically, the orientation-sensitive switch may be configured for being switched when the mounting platform reaches the predetermined switch-off orientation. Specifically, the orientation-sensitive switch may comprise at least one switch selected from the group consisting of: a mechanical switch, specifically a pushbutton, more specifically a micro pushbutton; an electro-optical switch, specifically a light barrier; a sliding contact. Also other embodiments may be feasible. The orientation-sensitive switch may comprise at least one fixed switching element allocated to the mechanical frame and at least one moving switching element allocated to the mounting platform. The at least one fixed switching element and the moving switching element may comprise at least one opening, specifically at least one of a notch, a recess, a groove and a hole, and the other one of the fixed switching element and the moving switching element may comprise at least one device interacting with the opening, specifically mechanically and/or optically.

Specifically, the actuator may comprise a step motor or a servo motor and may further comprise a micro-controller or a computer. Thus, the actuator may be a controllable actuator which may be configured for accomplishing the essentially horizontal orientation when the mounting platform is in the switch-off orientation. One or more of the following parameters: rocking speed, tilting angle, final position and speed profile, may be definable or adaptable at any time. An additional orientation-sensitive switch such as a photoelectric relay may be used for calibration.

The main switch may be configured for switching an electric power supply of the actuator from at least one regular power supply circuit to at least one switch-off power supply circuit. As outlined above, the main switch may comprise at least one relay. Further details on the relay are provided above in more detail. The relay may be configured for selectively choosing a current flow through the regular power supply circuit or the switch-off power supply circuit. Specifically, the relay may be configured for selectively choosing the current flow through the regular power supply circuit or the switch-off power supply circuit by switching positions of the armature. The switch-off power supply circuit and the regular power supply circuit may be electric circuits which at least partially are connected in parallel. A parallel connection may refer to a connection of two-pole components in such a way that all their identical poles are commonly connected.

The term “regular power supply circuit” as used herein is a broad term and is to be given its ordinary and customary meaning to a person of ordinary skill in the art and is not to be limited to a special or customized meaning. The term specifically may refer, without limitation, to an arbitrary electrical circuit or part of an electrical circuit which is configured for controlling an electrical component such as an electric motor, specifically during a regular operation of a device. Specifically, the regular power supply circuit may be configured for controlling the actuator, more specifically the electric motor of the actuator, during a regular operation of the rocking shaker. Specifically, during a process of treating the at least one fluid sample mounted on the mounting platform, a power supply to the actuator may be provided by the regular power supply circuit. Specifically, the regular power supply circuit may comprise at least one potentiometer for adjusting the power supply to the actuator.

The term “switch-off power supply circuit” as used herein is a broad term and is to be given its ordinary and customary meaning to a person of ordinary skill in the art and is not to be limited to a special or customized meaning. The term specifically may refer, without limitation, to an arbitrary electrical circuit or part of an electrical circuit which is configured for controlling an electrical component such as an electric motor, specifically after a device is switched off. Specifically, the switch-off power supply circuit may be configured for controlling the actuator, more specifically the electric motor of the actuator, after the rocking shaker is switched off such as by manual switching by a user or by an external computer control. The orientation-sensitive switch may be located in the switch-off power supply circuit and the orientation-sensitive switch may be configured for interrupting the electric power supply through the switch-off power supply circuit. The switch-off power supply circuit may comprise at least one brake resistor. The brake resistor may be connected in series with the orientation-sensitive switch.

In a further aspect of the present invention, a system comprising at least one rocking shaker as described above or as will further be described below in more detail is disclosed. The system further comprises at least one sample holder mounted to the mounting platform of the rocking shaker.

The term “system” as used herein is a broad term and is to be given its ordinary and customary meaning to a person of ordinary skill in the art and is not to be limited to a special or customized meaning. The term specifically may refer, without limitation, to a group of at least two elements which may interact with each other in order to fulfill at least one common function. The at least two components may be handled independently or may be coupled, connectable or integratable in order to form a common component.

With regard to the sample holder, reference is made to the description above. Specifically, the sample holder may comprise the at least one microplate having a plurality of wells for receiving the liquid sample, specifically the at least one microplate having the at least one outside flange for mating with the mounting platform, more specifically with the positioning contour of the mounting platform, more specifically the microplate according to standard ANSI/SBS 2004, more specifically to at least one of standards ANSI/SBS 1-2004, ANSI/SBS 2-2004, ANSI/SBS 3-2004 and ANSI/SBS 4-2004.

Further, the system may comprise at least one liquid supply device. The term “liquid supply device” as used herein is a broad term and is to be given its ordinary and customary meaning to a person of ordinary skill in the art and is not to be limited to a special or customized meaning. The term specifically may refer, without limitation, to an arbitrary device which is configured for applying liquid, specifically a defined or desired amount of liquid, to another object. The amount of liquid may be adjustable. The liquid supply device may specifically comprise one or more pipetting units. The pipetting unit may comprise at least one chamber being configured for holding or receiving at least one liquid. The pipetting unit may be configured for creating a partial vacuum above the chamber and for selectively releasing the partial vacuum to draw up and dispense the liquid. However, also other embodiments of the liquid supply device may be feasible. Further, the system may comprise one or more gripper arms. The gripper arm may be configured for placing the sample holder one the mounting platform as well as for removing the sample holder from the mounting platform.

In a further aspect of the present invention, a method for treating at least one fluid sample is disclosed.

The method comprises the method steps as given in the independent claim and as listed as follows. The method steps may be performed in the given order. However, other orders of the method steps are feasible. Further, one or more of the method steps may be performed in parallel and/or in a timely overlapping fashion. Further, one or more of the method steps may be performed repeatedly. Further, additional method steps may be present which are not listed.

The method comprises the following steps:
a) providing at least one rocking shaker as described above or as will further be described below in more detail;
b) mounting at least one sample holder holding the fluid sample onto the mounting platform of the rocking shaker;
c) switching on the rocking shaker and shaking the fluid sample;
d) switching off the rocking shaker; and
e) bringing, by the rocking shaker, the mounting platform into the predetermined switch-off orientation.

The method may be a computer-implemented method. The term “computer implemented method” as used herein is a broad term and is to be given its ordinary and customary meaning to a person of ordinary skill in the art and is not to be limited to a special or customized meaning. The term specifically may refer, without limitation, to a method involving at least one computer and/or at least one computer network. The computer and/or computer network may comprise at least one processor which is configured for performing at least one of the method steps of the method according to the present invention. Specifically, the method steps c) to e) may be performed by the computer and/or computer network. The method may be performed completely automatically, specifically without user interaction.

The term “providing”, as used herein, is a broad term and is to be given its ordinary and customary meaning to a person of ordinary skill in the art and is not to be limited to a special or customized meaning. The term specifically may refer, without limitation, to a process of making available one or more needed objects.

The term “mounting”, as used herein, is a broad term and is to be given its ordinary and customary meaning to a person of ordinary skill in the art and is not to be limited to a special or customized meaning. The term specifically may refer, without limitation, to a process of placing at least one element on a surface of another object. In the mounted state, a moving of the sample holder relative to the mounting platform may be prevented or reduced at least to a large extent. The sample holder may be mounted onto the mounting platform of the rocking shaker in a releasable manner.

The terms “switching on” and “switching off”, as used herein, are broad terms and are to be given its ordinary and customary meanings to a person of ordinary skill in the art and are not to be limited to a special or customized meaning. The terms specifically may refer, without limitation, to processes of making a machine start or stop working. The switching on and switching off may be performed by manual switching and/or by external computer control.

In a further aspect of the present invention, a use of a rocking shaker as described above or as will further be described below in more detail is disclosed, for a purpose of use selected from the group consisting of:
adding a liquid to a cell suspension while continuously mixing the cell suspension on the rocking shaker; and
adding a liquid to a suspension of beads or particles while continuously mixing the suspension on the rocking shaker.

The adding of the liquid to the cell suspension and/or the adding of the liquid to the suspension of beads or particles may be performed at certain points in time within an at least partially automated process.

Specifically, the rocking shaker may be used for one or more of the following purposes:
a dilution of a freshly thawed cell stock suspension with a culture medium;
an addition of a cryo medium to a cell suspension prior to cryo storage;
an addition of a solvent, a reactant or another liquid component to a chemical reaction mix;
an addition of at least one liquid component to a suspension of beads at any stage of a bead-based assay; and
an addition of a cell suspension to a suspension of beads in a bead-based cellular assay or bead based cell separation.

Further disclosed and proposed herein is a computer program including computer-executable instructions for performing the method according to the present invention in one or more of the embodiments enclosed herein when the instructions are executed on a computer or computer network. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps c) to e) as indicated above may be performed by using a computer or a computer network, preferably by using a computer program.

Further disclosed and proposed herein is a computer program product having program code means, in order to perform the method, specifically one or even all of method steps c) to e), according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method, specifically one or even all of method steps c) to e), according to one or more of the embodiments disclosed herein.

Further disclosed and proposed herein is a non-transient computer-readable medium including instructions that, when executed by one or more processors, cause the one or more processors to perform the method, specifically one or even all of method steps c) to e), according to one or more of the embodiments disclosed herein.

Further disclosed and proposed herein is a computer program product with program code means stored on a machine-readable carrier, in order to perform the method, specifically one or even all of method steps c) to e), according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the method, specifically one or even all of method steps c) to e), according to one or more of the embodiments disclosed herein.

Referring to the computer-implemented aspects of the invention, one or more of the method steps, specifically one or even all of method steps c) to e), of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method, specifically one or even all of method steps c) to e), according to one of the embodiments described in this description,
a computer loadable data structure that is adapted to perform the method, specifically one or even all of method steps c) to e), according to one of the embodiments described in this description while the data structure is being executed on a computer,
a computer program, wherein the computer program is adapted to perform the method, specifically one or even all of method steps c) to e), according to one of the embodiments described in this description while the program is being executed on a computer,
a computer program comprising program means for performing the method, specifically one or even all of method steps c) to e), according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method, specifically one or even all of method steps c) to e), according to one of the embodiments described in this description after having been loaded into a main and/or working storage of a computer or of a computer network, and
a computer program product having program code means, wherein the program code means can be stored or are stored on a storage medium, for performing the method, specifically one or even all of method steps c) to e), according to one of the embodiments described in this description, if the program code means are executed on a computer or on a computer network.

The methods and devices according to the present invention provide a large number of advantages over known methods and devices.

Specifically, the rocking shaker may allow a simultaneous mixing and diluting of cell suspensions using a commercially available liquid supply device. Cell suspensions may be mixed gently. Different microplates according to standard ANSI/SBS 2004 may be used as sample holders. Thus, a preparation of a broad range of final cell suspension volume may be possible without changing the equipment and material used. For example, the preparation of 2 ml or 100 ml may be possible with one set of equipment without affecting the efficiency and quality of the final sample. This allows an economical use of valuable reagents as needed. An automation may provide a very high reproducibility of a cell treatment at a critical stage between thawing and seeding. In addition, flexible programming options may allow a preparation of cell suspensions for seeding to be optimized to an extent that cannot be achieved manually. For example, shaking and addition rates may be varied during dilution so that stress to the cells is minimal at all times. Thus, invalid assays caused by fluctuating cell culture quality may be avoided. A particular technical advantage of the rocking shaker is that it may be integrated into robotic systems without great effort.

The rocking shaker may have a footprint according to standard ANSI/SBS 2004 so that it can be installed on any deck of a liquid handling robot. The rocking shaker may be at the same time footprint and fixation (“nest”) for a microplate according to standard ANSI/SBS 2004, so that the microplate does not slip during shaking. The rocking shaker may be controlled manually or through a computer interface. A tilting frequency may be variable. After switching off, the footprint may automatically be brought into a horizontal orientation such that labware may either be handled with a gripper arm or a pipetting unit is given a defined position in the x, y and z directions. The rocking shaker may be integrated without effort into simple automated systems such as into the “Felix” pipetting system provided by “Analytik Jena” without a gripper arm or independent pipetting channels.

An electric motor such as a gear motor or a computer or microcontroller controlled servo motor or a stepper motor may be used. For gear motors, a zero position may be defined and set via a light barrier or a microswitch. For servo motors and stepper motors, this may also be possible electronically via a servo position or a step counter. Servo motors and stepper motors may allow a setting of a tilting frequency and tilting amplitude without mechanical intervention via software. Even complex profiles such as a “soft start” profile or a profile having a time-variable tilting amplitude and a specific inclination of the mounting platform such as for collecting liquid residues may be easily programmable. In addition to push-rod mechanisms, a mechanical coupling of stepper motors to the mounting platform may also be achieved by rope pull, toothed racks or belts, specifically toothed belts. A use of springs in connection between the mounting platform and the actuator may reduce a mechanical load, e.g. in an event of incorrect operation or a crash of the actuator.

Summarizing and without excluding further possible embodiments, the following embodiments may be envisaged:

Embodiment 1: A rocking shaker for treating at least one fluid sample, comprising:
i. at least one mechanical frame, the mechanical frame comprising at least one tilting axle;
ii. at least one mounting platform being tiltably mounted on the tilting axle, the mounting platform being configured for receiving at least one sample holder;
iii. at least one actuator, the actuator being configured for periodically tilting the mounting platform about the tilting axle over an angular orientation range; and
iv. at least one driving circuit for electrically driving the actuator, the driving circuit comprising at least one switch-off device, the switch-off device being configured for automatically bringing the mounting platform in a predetermined switch-off orientation when the rocking shaker is switched off.

Embodiment 2: The rocking shaker according to the preceding embodiment, wherein the switch-off device is configured for automatically bringing the mounting platform in the predetermined switch-off orientation independent from a point in time at which the rocking shaker is switched off.

Embodiment 3: The rocking shaker according to any one of the preceding embodiments, wherein the mounting platform is in an essentially horizontal orientation when the mounting platform is in the switch-off orientation.

Embodiment 4: The rocking shaker according to any one of the preceding embodiments, wherein the mounting platform comprises at least one essentially flat mounting surface and at least one positioning contour for positioning the sample holder on the mounting platform.

Embodiment 5: The rocking shaker according to the preceding embodiment, wherein the positioning contour comprises at least one of a groove and a frame.

Embodiment 6: The rocking shaker according to any one of the two preceding embodiments, wherein the positioning contour is configured for mating with at least one microplate according to standard ANSI/SBS 2004, more specifically to at least one of standards ANSI/SBS 1-2004, ANSI/SBS 2-2004, ANSI/SBS 3-2004 and ANSI/SBS 4-2004.

Embodiment 7: The rocking shaker according to any one of the three preceding embodiments, wherein the positioning contour comprises a circumferential groove for mating with at least one flange of at least one microplate, specifically with a bottom outside flange of at least one microplate according to standard ANSI/SBS 3-2004.

Embodiment 8: The rocking shaker according to any one of the preceding embodiments, wherein the mounting platform has an essentially rectangular footprint having a length L and a width W, specifically a length L of 80 mm to 200 mm, more specifically a length of 100 mm to 150 mm, more specifically a length of 128 mm, and, specifically, a width W of 40 mm to 120 mm, specifically a width of 50 mm to 110 mm, more specifically a width of 86 mm.

Embodiment 9: The rocking shaker according to any one of the preceding embodiments, wherein the actuator comprises at least one electric motor, specifically at least one of: an electric DC motor; a stepper motor.

Embodiment 10: The rocking shaker according to any one of the preceding embodiments, wherein the actuator has an adjustable agitation speed.

Embodiment 11: The rocking shaker according to any one of the preceding embodiments, wherein the rocking shaker comprises at least one of an external electric power supply and an internal electric power storage device, specifically at least one of an accumulator and a battery.

Embodiment 12: The rocking shaker according to any one of the preceding embodiments, wherein the actuator comprises an eccentric drive.

Embodiment 13: The rocking shaker according to any one of the preceding embodiments, wherein the switch-off device comprises at least one main switch and at least one orientation-sensitive switch, wherein the main switch is configured for being actuated externally, and wherein the orientation-sensitive switch is configured for being switched by an orientation of the mounting platform.

Embodiment 14: The rocking shaker according to the preceding embodiment, wherein the orientation-sensitive switch is configured for being switched when the mounting platform reaches the predetermined switch-off orientation.

Embodiment 15: The rocking shaker according to any one of the two preceding embodiments, wherein the orientation-sensitive switch comprises at least one switch selected from the group consisting of: a mechanical switch, specifically a pushbutton, more specifically a micro pushbutton; an electro-optical switch, specifically a light barrier.

Embodiment 16: The rocking shaker according to the preceding embodiment, wherein the orientation-sensitive switch comprises at least one fixed switching element allocated to the mechanical frame and at least one moving switching element allocated to the mounting platform.

Embodiment 17: The rocking shaker according to the preceding embodiment, wherein the at least one fixed switching element and the moving switching element comprise at least one opening, specifically at least one of a notch, a recess, a groove and a hole, and wherein the other one of the fixed switching element and the moving switching element comprises at least one device interacting with the opening, specifically mechanically and/or optically.

Embodiment 18: The rocking shaker according to any one of the five preceding embodiments, wherein the main switch is configured for switching an electric power supply of the actuator from at least one regular power supply circuit to at least one switch-off power supply circuit, wherein the orientation-sensitive switch is located in the switch-off power supply circuit and wherein the orientation-sensitive switch is configured for interrupting the electric power supply through the switch-off power supply circuit.

Embodiment 19: The rocking shaker according to the preceding embodiment, wherein the switch-off power supply circuit and the regular power supply circuit are electric circuits which at least partially are connected in parallel.

Embodiment 20: The rocking shaker according to any one of the two preceding embodiments, wherein the regular power supply circuit comprises at least one potentiometer for adjusting a power supply to the actuator.

Embodiment 21: The rocking shaker according to any one of the three preceding embodiments, wherein the switch-off power supply circuit comprises at least one brake resistor, the brake resistor being connected in series with the orientation-sensitive switch.

Embodiment 22: The rocking shaker according to any one of the four preceding embodiments, wherein the main switch comprises at least one relay, wherein the relay is configured for selectively choosing a current flow through the regular power supply circuit or the switch-off power supply circuit.

Embodiment 23: The rocking shaker according to any one of the ten preceding embodiments, wherein the main switch is switchable by at least one of: by manual switching and by external computer control.

Embodiment 24: The rocking shaker according to the preceding embodiment, wherein the main switch comprises a switching element switchable by a user, wherein the switching element has at least two switching positions, the switching positions comprising an ON position in which the actuator is switched on, the switching positions further comprising an OFF position in which the actuator is switched off, and optionally further a computer control position in which a switching on and a switching off of the actuator is controllable by an external computer.

Embodiment 25: The rocking shaker according to any one of the two preceding embodiments, wherein the main switch comprises a main switching circuit, wherein the main switching circuit comprises at least two branches connected in a parallel fashion, wherein a current flow is switchable between the branches, wherein in at least one of the branches a computer controllable switch is located.

Embodiment 26: A system comprising at least one rocking shaker according to any one of the preceding embodiments, the system further comprising at least one sample holder mounted to the mounting platform of the rocking shaker.

Embodiment 27: The system according to the preceding embodiment, wherein the sample holder comprises at least one microplate having a plurality of wells for receiving the liquid sample, specifically at least one microplate having at least one outside flange for mating with the mounting platform, more specifically with a positioning contour of the mounting platform, more specifically a microplate according to standard ANSI/SBS 2004, more specifically to at least one of standards ANSI/SBS 1-2004, ANSI/SBS 2-2004, ANSI/SBS 3-2004 and ANSI/SBS 4-2004.

Embodiment 28: A method for treating at least one fluid sample, the method comprising:
a) providing at least one rocking shaker according to any one of the preceding embodiments referring to a rocking shaker;
b) mounting at least one sample holder holding the fluid sample onto the mounting platform of the rocking shaker;
c) switching on the rocking shaker and shaking the fluid sample;
d) switching off the rocking shaker; and
e) bringing, by the rocking shaker, the mounting platform into the predetermined switch-off orientation.

Embodiment 29: A use of a rocking shaker according to any one of the preceding embodiments referring to a rocking shaker, for a purpose of use selected from the group consisting of:
adding a liquid to a cell suspension while continuously mixing the cell suspension on the rocking shaker; and
adding a liquid to a suspension of beads or particles while continuously mixing the suspension on the rocking shaker.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIGS. 1A to 1C show different components of a rocking shaker according to the present invention in various perspective and side views;

FIGS. 2A and 2B show a rocking shaker according to the present invention in a perspective view (FIG. 2A) and in a disassembled view (FIG. 2B);

FIGS. 3A and 3B respectively show components of two further embodiments of a rocking shaker according to the present invention in various side views; and

FIGS. 4A and 4B show two exemplarily driving circuits for electrically driving the actuator of a rocking shaker according to the present invention.

### DETAILED DESCRIPTION OF THE EMBODIMENTS

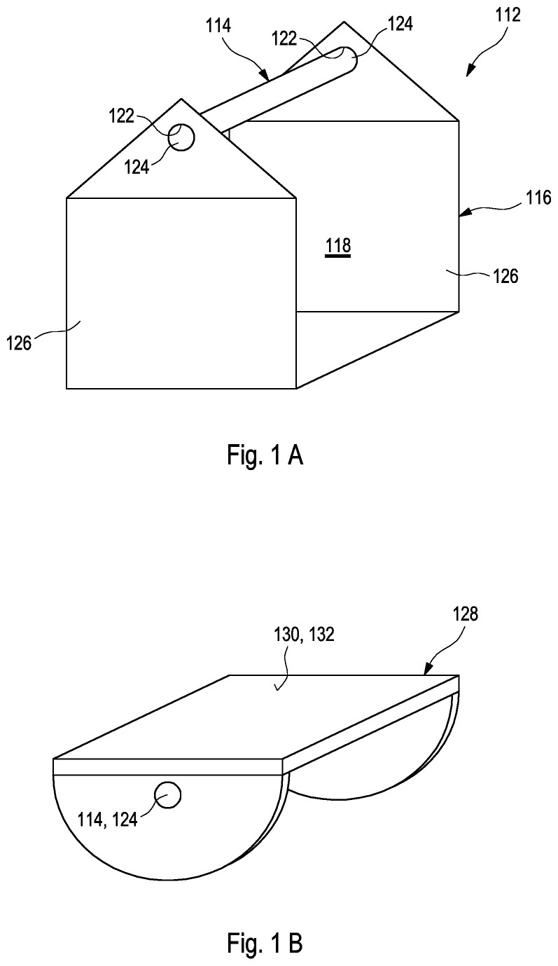

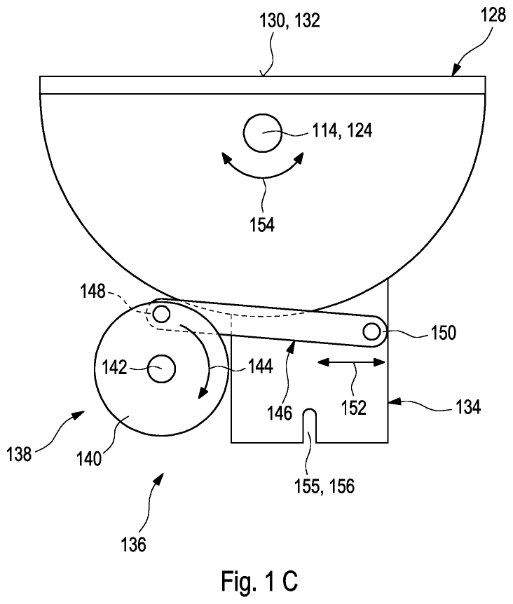

FIGS. 1A to 1C show different components of a rocking shaker 110 according to the present invention in various perspective and side views.

In FIG. 1A, a mechanical frame 112 of the rocking shaker 110 is illustrated in a perspective view. The mechanical frame 112 comprises least one tilting axle 114. The tilting axle 114 may specifically be an elongated element, specifically an essentially cylindrical element. The tilting axle 114 may be configured for supporting one or more rotating components. The tilting axle 114 may specifically be a stationary element. Thus, the one or more rotating components may be rotatably mounted on the tilting axle 114.

Specifically, the mechanical frame 112 may comprise a housing 116 of the rocking shaker 110 or may form part of the housing 116 of the rocking shaker 110. The housing 116 may be configured for receiving one or more components of the rocking shaker 110 as will be further described below in more detail. For this purpose, the mechanical frame 112 may comprise at least one hollow space 118. The mechanical frame 112 may specifically comprise two recesses 122 for supporting the tilting axle 114 which may be configured for respectively receiving an end 124 of the tilting axle 114. Specifically, the recesses 122 may be located on two opposing sidewalls 126 of the mechanical frame 112.

In FIG. 1B, a mounting platform 128 of the rocking shaker 110 is illustrated in a perspective view. The mounting platform 128 is tiltably mounted on the tilting axle 114. The mounting platform 128 is configured for receiving at least one sample holder (not shown in FIG. 1B).

The mounting platform 128 may comprise at least one support area 130. The at least one fluid sample, specifically the at least one sample holder comprising the fluid sample, may be configured for being mounted on the mounting platform 128. The mounting platform 128 may specifically comprise at least one essentially flat mounting surface 132 and at least one positioning contour (not shown in FIG. 1B) for positioning the sample holder on the mounting platform 128.

In FIG. 1C, the mounting platform 128 of the rocking shaker 110 as well as further components of the rocking shaker 110 are illustrated in a side view.

Specifically, the rocking shaker 110 may comprise at least one rotating component 134. The rotating component 134 may have at least one through hole and the tilting axle 114 may be received within the through hole of the rotating component 134 (not shown in FIG. 1C). The mounting platform 128 may be fixedly connected to the at least one rotating component 134 (not shown in FIG. 1C).

The rocking shaker 110 comprises the at least one actuator 136. The actuator 136 may specifically comprise at least one electric motor (not shown in FIG. 1C). The motor may be mechanically coupled to the mounting platform 128. Exemplarily, as illustrated in FIG. 1C, the actuator 136 may comprise an eccentric drive 138.

The eccentric drive 138 may specifically comprise at least one disk 140. The disk 140 may be configured for rotating around an axis 142 such as indicated by arrow 144. Further, the eccentric drive 138 may comprise at least one eccentric rod 146 which may be attached to the disk 140. Specifically, a first end 148 of the eccentric rod 146 may be attached to the disk 140 in such a way that an opposing second end 150 of the eccentric rod 146 may impart into a translational movement such as a reciprocating motion, such as indicated with arrow 152. The second end 150 may be attached to the rotating component 134. Thus, due to the reciprocating motion of the second end 150 of the eccentric rod 146, the mounting platform 128 may be tilted about the tilting axle 114 such as indicated with arrow 154. The rotating element 134 may further comprise at least one opening 155 such as a notch 156 which may be configured for interacting with at least one fixed switching element of a switch. Further details are described below in more detail.

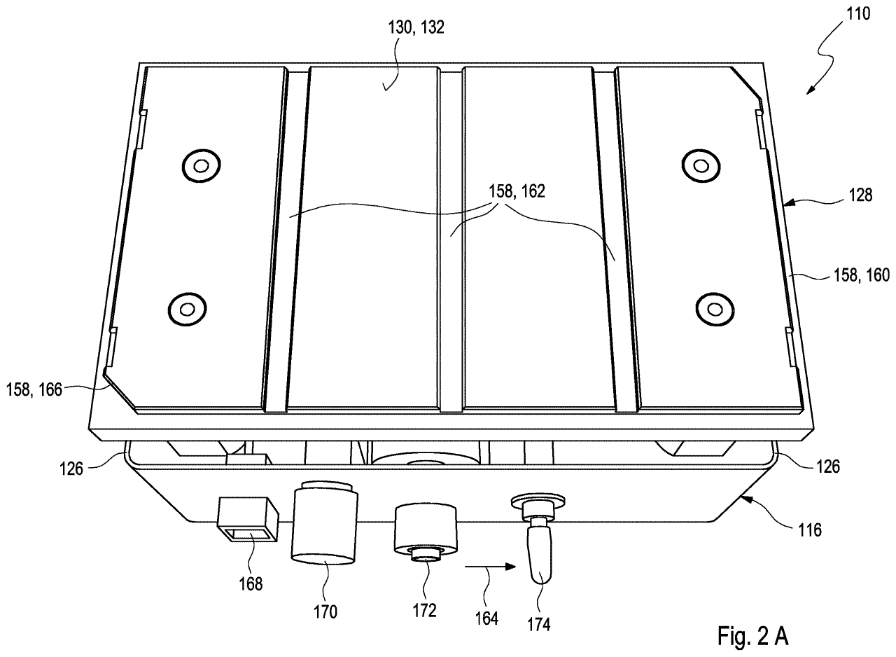

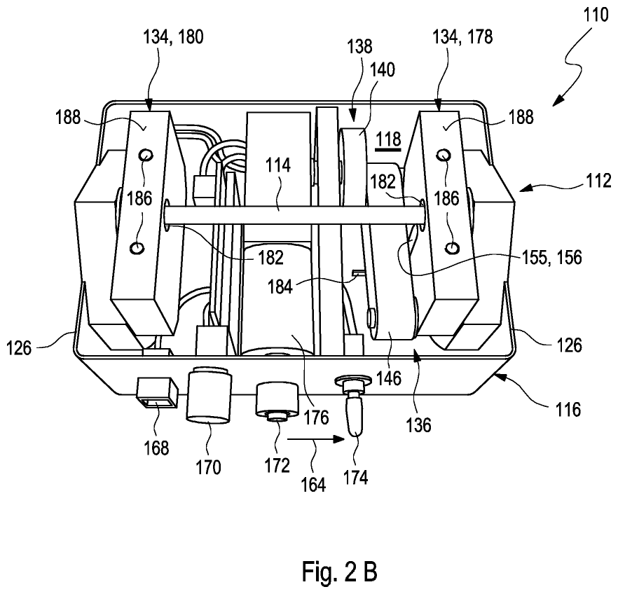

FIGS. 2A and 2B show a rocking shaker 110 according to the present invention in a perspective view (FIG. 2A) and in a disassembled view (FIG. 2B). Components of the rocking shaker 110 as illustrated in FIGS. 2A and 2B correspond as least partially to components of the rocking shaker 110 as illustrated in FIGS. 1A to 1C. Thus, reference to the description of FIGS. 1A to 1C above is made.

In FIG. 2A, the mounting platform 128 is depicted. The mounting platform 128 may specifically comprise the at least one essentially flat mounting surface 132 and at least one positioning contour 158 for positioning the sample holder (not shown) on the mounting platform 128. The positioning contour 158 may specifically be configured for mating with the at least one microplate according to standard ANSI/SBS 2004, more specifically to at least one of standards ANSI/SBS 1-2004, ANSI/SBS 2-2004, ANSI/SBS 3-2004 and ANSI/SBS 4-2004. Specifically, the positioning contour 158 may comprise a circumferential groove 160 for mating with at least one flange of at least one microplate, specifically with a bottom outside flange of at least one microplate according to standard ANSI/SBS 3-2004. Further, the positioning contour 158 may comprise at least one groove 162 which extends perpendicular to an axis of extension 164 of the mounting platform 128. Specifically, the positioning contour 158 may comprise three of the grooves 162 which are arranged in a distance to each other. Specifically, the positioning contour 158 may have a chamfer 166 such as a 45° chamfer. The chamfer may be configured for guiding the sample holder onto the mounting platform 128.

In FIG. 2A, the housing 116 of the rocking shaker 110 is further illustrated. On the housing 116 an USB port 168 for a computer control, a speed controller 170, a power supply 172 and a toggle switch 174 may be mounted.

In FIG. 2B, the mounting platform 128 of the rocking shaker 110 is disassembled. Thus, a view into the hollow space 118 of the mechanical frame 112 is enabled. The actuator 136 can be seen in FIG. 2B. The actuator 136 may comprise an electric motor 176. The electric motor 176 may specifically be a 12V gear motor. Further, the actuator 136 may comprise the eccentric drive 138 having the disk 140 and the eccentric rod 146.

Further, the at least one rotating component 134 can be seen in FIG. 2B. Specifically, the rocking shaker 110 may comprise at least one first rotating component 178 and at least one second rotating component 180. The first rotating component 178 and the second rotating component 180 may respectively have at least one through hole 182 and the tilting axle 114 may be received within the through holes 182 of the first rotating component 178 and the second rotating component 180. The first rotating component 178 and the second rotating component 180 may respectively be located on opposing ends of the tilting axle 114. The first rotating component 178 may the attached to the eccentric drive 138 via the eccentric rod 146. The first rotating component 178 may comprise the notch 156. Further, a micro switch 184 is illustrated in FIG. 2B. The mounting platform 128 may be fixedly connectable to the first rotating component 178 and the second rotating component 180 such as by at least one screw connection. In FIG. 2B, screw holes 186 located on support surfaces 188 of the first rotating component 178 and the second rotating component 180 are illustrated.

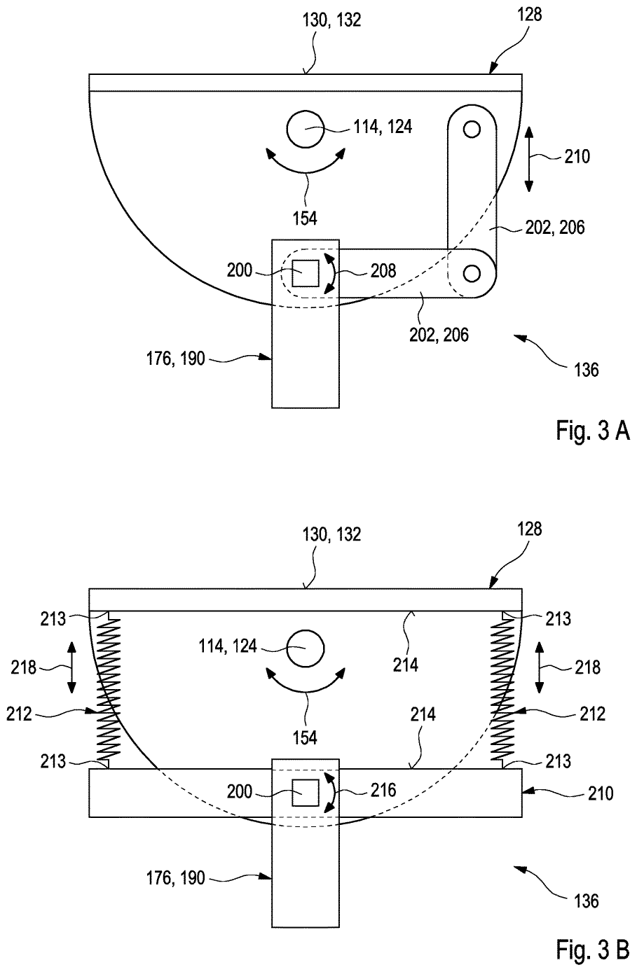

FIGS. 3A and 3B respectively show components of two further embodiments of a rocking shaker 110 according to the present invention in various side views. Specifically, the mounting platform 128 of the rocking shaker 110 as well as further components of the rocking shaker 110 such as the actuator 136 are illustrated in a side view. Components of the rocking shaker 110 as illustrated in FIGS. 3A and 3B correspond as least partially to components of the rocking shaker 110 as illustrated in FIGS. 1A to 1C. Thus, reference to the description of FIGS. 1A to 1C above is made. There are differences in the design of the actuator 136.

The actuator 136 as illustrated in FIG. 3A comprises the electric motor 176. Specifically, the electric motor 176 may be a servo motor 190. The servo motor 190 may comprise at least one motor shaft 200. Further, the actuator 136 may comprise at least two push rods 202. The two push rods 202 may be connected to each other. Specifically, the actuator 136 may comprise at least one first push rod 202 and at least one second push rod 204. The first push rod 202 may be connected to the motor shaft 200 of the servo motor 190. The second push rod 204 may be connected to the mounting platform 128. By a rotational movement of the first push rod 202 such as indicated with arrow 208, a translational movement such as a reciprocating motion of the second push rod 204 such as indicated with arrow 210 may occur. Thus, due to the reciprocating motion of the second push rod 204, the mounting platform 128 may be tilted about the tilting axle 114 such as indicated with arrow 154.

The actuator 136 as illustrated in FIG. 3B comprises the electric motor 176 which may be the servo motor 190. The servo motor 190 may comprise the at least one motor shaft 200. Further, the actuator 136 may comprise at least one plate 210. The plate 210 may be connected to the motor shaft 200 of the servo motor 190. Thus, the plate 210 and the mounting platform 128, specifically the essentially flat mounting surface 132, may be arranged in a distance to each other. The actuator 136 may further comprise at least two spring elements 212. The spring elements 212 may be arranged between the plate 210 and the mounting platform 128. Specifically, the spring elements 212 may respectively comprise at least two opposing ends which may respectively be attached to two opposing surfaces of the plate 210 and the mounting platform 128.

By a rotational movement of the plate 210 such as indicated with arrow 216, a translational movement such as a reciprocating motion of the spring elements 212 such as indicated with arrows 218 may occur. Thus, due to the reciprocating motion of spring elements 212, the mounting platform 128 may be tilted about the tilting axle 114 such as indicated with arrow 154.

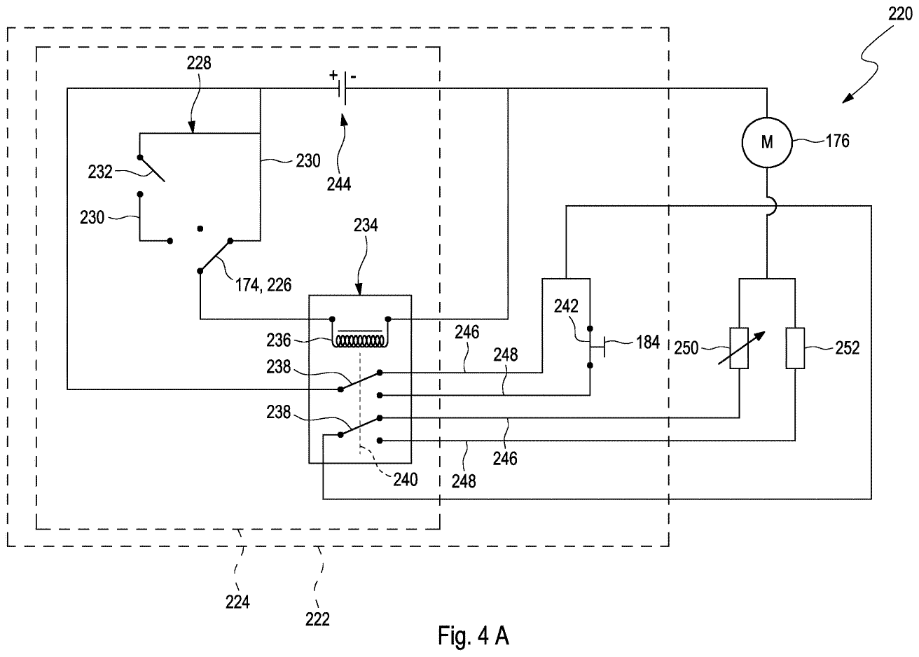

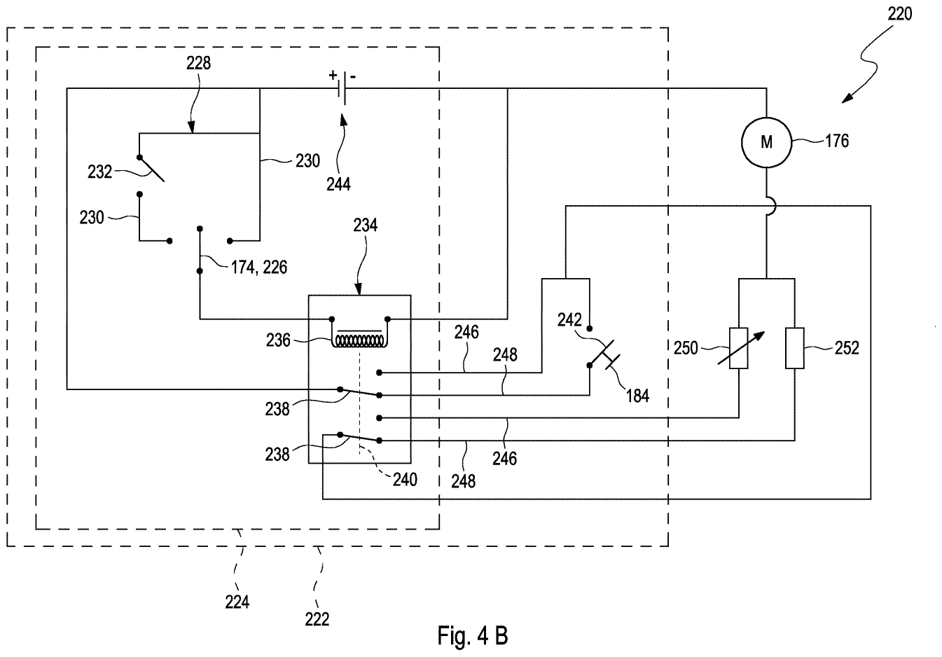

FIGS. 4A and 4B show two exemplarily driving circuits 220 for electrically driving the actuator 136 of a rocking shaker 110 according to the present invention. The driving circuits 220 according to FIGS. 4A and 4B may specifically correspond to driving circuits 220 for electrically driving the actuator 136 of the rocking shaker 110 having components as illustrated in FIGS. 1A to 1C. Thus, reference to the description of FIGS. 1A to 1C above is made.

The driving circuit 220 comprises at least one switch-off device 222. The switch-off device 222 is configured for automatically bringing the mounting platform 128 in a predetermined switch-off orientation when the rocking shaker 110 is switched off. The switch-off device 222 may comprise at least one main switch 224. The main switch 224 may be configured for being actuated externally. Specifically, the main switch 224 may comprise a switching element 226 switchable by a user. Exemplarily, the switching element 226 may be or may comprise the toggle switch 174. The switching element 226 may have at least two switching positions. In the embodiment according to FIGS. 4A and 4B, the switching element 226 may have three switching positions.

The switching positions may comprise an ON position in which the actuator 136 is switched on. In the embodiment as illustrated in FIG. 4A, the switching element 226 is in the ON position in which the actuator 136 is switched on. Further, the switching positions may comprise a computer control position in which a switching on and a switching off of the actuator 136 is controllable by an external computer. The switching positions may further comprise an OFF position in which the actuator 136 is switched off. The main switch 224 may comprise a main switching circuit 228. The main switching circuit 228 may comprise at least two branches 230 connected in a parallel fashion. A current flow may be switchable between the branches 230. In at least one of the branches 230 a computer controllable switch 232 may be located.

Further, specifically, the main switch 224 may comprise at least one relay 234. The relay 234 may specifically comprise at least one excitation coil 236. Further, the relay 234 may comprise at least one, specifically two, movable armatures 238. The movable armatures 238 may be ferromagnetic. A current in the excitation coil 238 may generate a magnetic flux through a ferromagnetic core of the excitation coil 238 and the movable armatures 238. At an air gap, force may be applied to the armatures 238 such as indicated with dashed line 240, causing it to switch one or more contacts. The armatures 238 may be returned to its initial position such as by a spring force as soon as the excitation coil 238 is no longer energized.

Further, the switch-off device 222 may comprise at least one orientation-sensitive switch 242. The orientation-sensitive 242 switch may be configured for being switched by an orientation of the mounting platform 128. Specifically, the orientation-sensitive switch 242 may be configured for being switched when the mounting platform 128 reaches the predetermined switch-off orientation. Specifically, the orientation-sensitive switch 128 may comprise the micro pushbutton 184. The orientation-sensitive switch 242 may comprise at least one fixed switching element allocated to the mechanical frame and at least one moving switching element allocated to the mounting platform 128. Exemplarily, the moving switching element may correspond to the rotating component 134 having the at least one notch 156 such as illustrated in FIG. 1C. Further, the fixed switching element may comprise at least one device interacting with the notch 156, specifically mechanically and/or optically.

The main switch 224 may be configured for switching an electric power supply 244 of the actuator 136 from at least one regular power supply circuit 246 to at least one switch-off power supply circuit 248. The switch-off power supply circuit 246 and the regular power supply circuit 248 may be electric circuits which at least partially are connected in parallel. As outlined above, the main switch 224 may comprise the at least one relay 234. The relay 234 may be configured for selectively choosing a current flow through the regular power supply circuit 246 or the switch-off power supply circuit 248, specifically by switching positions of the armatures 238.

In FIG. 4A, the switching element 226 may be in one of the ON positions. The electric power supply 244 of the actuator 136 may be switched to the regular power supply circuit 246 by relay 234. The regular power supply circuit 246 may be configured for controlling the electric motor 176, specifically during a regular operation of the rocking shaker 110. Specifically, during a process of treating the at least one fluid sample mounted on the mounting platform 128, a power supply to the actuator 136 may be provided by the regular power supply circuit 246. Specifically, the regular power supply circuit 246 may comprise at least one potentiometer 250 for adjusting a power supply to the actuator 136.

In FIG. 4B, the switching element 226 may be in the OFF position. The electric power supply 244 of the actuator 136 may be switched to the switch-off power supply circuit 248 by relay 234. The switch-off power supply circuit 248 may be configured for controlling the electric motor 176, specifically after the rocking shaker 110 is switched off such as by manual switching of the toggle switch 174. The orientation-sensitive switch 242 may be located in the switch-off power supply circuit 248 and the orientation-sensitive switch 242 may be configured for interrupting the electric power supply through the switch-off power supply circuit 248. The switch-off power supply circuit may comprise at least one brake resistor 252. The brake resistor 252 may be connected in series with the orientation-sensitive switch 242.

List of reference numbers

| | |
|---|---|
| 110 | rocking shaker |
| 112 | mechanical frame |
| 114 | tilting axle |
| 116 | housing |
| 118 | hollow space |
| 122 | recess |
| 124 | end |
| 126 | sidewall |
| 128 | mounting platform |
| 130 | support area |
| 132 | essentially flat mounting surface |
| 134 | rotating component |
| 136 | actuator |
| 138 | eccentric drive |
| 140 | disk |
| 142 | axis |
| 144 | arrow |
| 146 | eccentric rod |
| 148 | first end |
| 150 | second end |
| 152 | arrow |
| 154 | arrow |
| 155 | opening |
| 156 | notch |
| 158 | positioning centaur |
| 160 | circumferential groove |
| 162 | groove |
| 164 | axis of extension |
| 166 | chamfer |
| 168 | USB port |
| 170 | speed controller |
| 172 | power supply |
| 174 | toggle switch |
| 176 | electric motor |
| 178 | first rotating component |
| 180 | second rotating component |
| 182 | through hole |
| 184 | micro pushbutton |
| 186 | screw hole |
| 188 | support surface |
| 190 | servo motor |
| 200 | motor shaft |
| 202 | push rod |
| 204 | first push rod |
| 206 | second push rod |
| 208 | arrow |
| 210 | plate |
| 212 | spring elements |
| 213 | end |
| 214 | surface |
| 216 | arrow |
| 218 | arrow |
| 220 | driving circuit |
| 222 | switch-off device |
| 224 | main switch |
| 226 | switching element |
| 228 | main switching circuit |
| 230 | branch |
| 232 | computer controllable switch |
| 234 | relay |
| 236 | excitation coil |
| 238 | armature |
| 240 | dashed line |
| 242 | orientation-sensitive switch |
| 244 | electric power supply |
| 246 | regular power supply circuit |
| 248 | switch-off power supply circuit |
| 250 | potentiometer |
| 252 | brake resistor |

1-15. (canceled)

16. A rocking shaker for treating at least one fluid sample, comprising:
i. at least one mechanical frame, the mechanical frame comprising at least one tilting axle;
ii. at least one mounting platform being tiltably mounted on the tilting axle, the mounting platform being configured for receiving at least one sample holder;
iii. at least one actuator, the actuator being configured for periodically tilting the mounting platform about the tilting axle over an angular orientation range; and
iv. at least one driving circuit for electrically driving the actuator, the driving circuit comprising at least one switch-off device, the switch-off device being configured for automatically bringing the mounting platform in a predetermined switch-off orientation when the rocking shaker is switched off.

17. The rocking shaker according to claim 16, wherein the switch-off device is configured for automatically bringing the mounting platform in the predetermined switch-off orientation independent from a point in time at which the rocking shaker is switched off.

18. The rocking shaker according to claim 16, wherein the mounting platform is in an essentially horizontal orientation when the mounting platform is in the switch-off orientation.

19. The rocking shaker according to claim 16, wherein the mounting platform comprises at least one essentially flat mounting surface and at least one positioning contour for positioning the sample holder on the mounting platform.

20. The rocking shaker according to claim 16, wherein the positioning contour is configured for mating with at least one microplate according to standard ANSI/SBS 2004.

21. The rocking shaker according to claim 16, wherein the positioning contour is configured for mating with at least one microplate according to at least one of standards ANSI/SBS 1-2004, ANSI/SBS 2-2004, ANSI/SBS 3-2004 and ANSI/SBS 4-2004.

22. The rocking shaker according to claim 16, wherein the switch-off device comprises at least one main switch and at least one orientation-sensitive switch, wherein the main switch is configured for being actuated externally, and wherein the orientation-sensitive switch is configured for being switched by an orientation of the mounting platform.

23. The rocking shaker according to claim 22, wherein the orientation-sensitive switch is configured for being switched when the mounting platform reaches the predetermined switch-off orientation, wherein the orientation-sensitive switch comprises at least one fixed switching element allocated to the mechanical frame and at least one moving switching element allocated to the mounting platform.

24. The rocking shaker according to claim 23, wherein one of the fixed switching element and the moving switching element comprises at least one opening, and wherein the other one of the fixed switching element and the moving switching element comprises at least one device interacting with the opening.

25. The rocking shaker according to claim 24, wherein the at least one device interacts with the opening mechanically and/or optically.

26. The rocking shaker according to claim 22, wherein the main switch is configured for switching an electric power supply of the actuator from at least one regular power supply circuit to at least one switch-off power supply circuit, wherein the orientation-sensitive switch is located in the switch-off power supply circuit and wherein the orientation-sensitive switch is configured for interrupting the electric power supply through the switch-off power supply circuit.

27. The rocking shaker according to claim 26, wherein the switch-off power supply circuit and the regular power supply circuit are electric circuits which at least partially are connected in parallel.

28. The rocking shaker according to claim 22, wherein the main switch is switchable by at least one of by manual switching and by external computer control, wherein the main switch comprises a switching element switchable by a user, wherein the switching element has at least two switching positions, the switching positions comprising an ON position in which the actuator is switched on, the switching positions further comprising an OFF position in which the actuator is switched off.

29. The rocking shaker according to claim 28, wherein the main switch comprises a computer control position in which a switching on and a switching off of the actuator is controllable by an external computer.

30. The rocking shaker according to claim 28, wherein the main switch comprises a main switching circuit, wherein the main switching circuit comprises at least two branches connected in a parallel fashion, wherein a current flow is switchable between the branches, wherein in at least one of the branches a computer controllable switch is located.

31. A system comprising at least one rocking shaker according to claim 16, the system further comprising at least one sample holder mounted to the mounting platform of the rocking shaker.

32. A method for treating at least one fluid sample, the method comprising: a) providing at least one rocking shaker according to claim 1; b) mounting at least one sample holder holding the fluid sample onto the mounting platform of the rocking shaker; c) switching on the rocking shaker and shaking the fluid sample; d) switching off the rocking shaker; and e) bringing, by the rocking shaker, the mounting platform into the predetermined switch-off orientation.

33. The method according to claim 32 further comprising the steps of adding a liquid to a cell suspension while continuously mixing the cell suspension on the rocking shaker, adding a liquid to a suspension of beads or particles while continuously mixing the suspension on the rocking shaker, or both.
